(19) United States
(12) Patent Application Publication
(10) Pub. No.: US 2002/0190817 A1
(43) Pub. Date: Dec. 19, 2002

(54) Amplitude adjustable dual mode dielectric resonator filter assembly

(76) Inventors: Stephen Berry, San Ramon, CA (US); Slawomir J. Fiedziuszko, Palo Alto, CA (US); Stephen Holme, San Ramon, CA (US)

Correspondence Address: JOYCE KOSINSKI, LORAL SPACE & COMMUNICATIONS LTD, 655 DEEP VALLEY DRIVE SUITE 303, ROLLING HILLS ESTATES, CA, 90274, US

(21) Appl. No.: 09/880,487

(22) Filed: Jun. 13, 2001

(51) Int. Cl. H01P 1/20

(52) U.S. Cl. 333/202; 333/28 R

(57) ABSTRACT

In a filter assembly having a bandpass filter and a group-delay equalizer coupled thereto by a circulator, there is disposed in the filter and/or the equalizer an electromagnetic wave propagation structure having a cavity with a plurality of tuning elements extending therein. The wave-propagation structure supports a first wave propagating in a first mode and a second wave propagating in a second mode. A first of the tuning elements is positioned to interact with the first wave, a second of the tuning elements is positioned to interact with the second wave, and a third of the tuning elements is positioned for coupling electromagnetic energy between the first wave and the second wave. A fourth of the tuning elements has an orientation perpendicular to an orientation of the third tuning element. Each of the first, the second and the third tuning elements is essentially non-lossy while the fourth tuning element is lossy for obtaining improved flatness of a spectral characteristic of amplitude versus frequency to electromagnetic waves propagating through the filter assembly. A ceramic resonator is located on a central axis of the cavity, and each of the tuning elements is directed toward the central axis. Each of the tuning elements may be constructed as screws for adjustment of depths of penetration of the screws into the cavity for interaction with the electromagnetic waves.

### BACKGROUND OF THE INVENTION

This invention relates to amplitude correction in a dual mode dielectric resonator filter assembly and, more particularly, to construction of a filter assembly having a spectral passband characteristic with reduced variation of insertion loss versus frequency.

A filter assembly, typically incorporating a bandpass filter and a group delay equalizer is often employed in a communication system such as a microwave system communicating via satellite. The bandpass filter and/or the group-delay equalizer may include a dielectric resonator. To insure the fidelity of the transmission, it is often necessary to control the spectral characteristic of the filter assembly passband, with respect to amplitude of signal versus frequency of the signal being communicated, to be flat in the sense that there is no more than a negligibly small variation in signal amplitude versus signal frequency over the passband of interest. Such control of the spectral characteristic has been accomplished in the past by the use of an amplitude equalizer.

Use of the amplitude equalizer, while accomplishing a correction of the spectral characteristic to obtain a desired flatness to the relation of amplitude versus frequency, suffers from the disadvantage of introducing an additional microwave component with the attendant undesirable extra volume, extra weight, and extra cost to the construction of the communication system. Generally, in the construction of a communication system, particularly in a system having a communication link via a satellite, it is important to reduce the volume and the weight of the microwave components to enable the satellite to carry other components of a payload.

### SUMMARY OF THE INVENTION

The aforementioned disadvantage is overcome and other advantages are provided by use of the invention in a filter assembly having a bandpass filter and a group-delay equalizer. By way of example, the group-delay equalizer comprises a cavity with a resonator centrally located therein. The invention is readily demonstrated in the case of the group delay equalizer, provided with mode tuning screws directed inwardly towards the resonator from an outer wall of the cavity, the tuning screws being oriented perpendicularly to each other and being located in a common plane oriented transversely to the resonator. For example, the resonator may be a ceramic resonator, and the cavity and the tuning screws are constructed of an electrically conductive metal. Each of the mode tuning screws is employed for adjustment of the propagation of respective ones of two electromagnetic waves propagating in orthogonal modes through the group-delay equalizer. Each of the mode tuning screws is oriented with respect to the electromagnetic field of a respective one of the propagating modes with which the screw is to interact. The screws are employed in a preferred embodiment of the invention, it being understood that an equivalent form of tuning element such as an electrically conductive post may be employed in the practice of the invention.

Also provided in the group-delay equalizer is a further tuning element in the form of a mode-coupling screw disposed in the same plane with the tuning screws, and oriented at 45 degrees with respect to the tuning screws to establish a desired amount of coupling of electromagnetic energy between the two modes. The mode-coupling screw is also constructed of an electrically conductive metal. Typically, the tuning and mode-coupling screws are silver plated for minimum loss.

In accordance with a preferred embodiment of the invention constructed of the foregoing cavity with the tuning and mode-coupling screws, an additional screw is placed in the same plane with the tuning screws, and is oriented perpendicularly to the mode-coupling screw. The additional screw is constructed of lossy material such as titanium which is lossy at microwave frequencies and absorbs a portion of the electromagnetic energy. The amount of penetration of the additional screw into the cavity is adjustable by rotation of the screw, wherein increased penetration provides for increased absorption of electromagnetic energy, to attain the desired spectral characteristic of amplitude versus frequency. It is noted also that, in the case of a cavity extending a multiple number of half-wavelengths along the direction of propagation of the electromagnetic energy, the mode coupling screw as well as the additional screw may be located in transverse plane(s) displaced from the plane of the mode tuning screws by one or more half wavelengths. The angulation of the additional screw is transverse to the mode-coupling screw for phase quadrature by rotation of the orientation of the additional screw by plus or minus 90 degrees about the wave propagation axis of the equalizer relative to the mode-coupling screw.

It is to be noted that the foregoing type of construction of the group-delay equalizer, namely the cavity plus resonator plus the tuning and mode-coupling screws, may be employed also in the bandpass filter. The invention may then be implemented by placing the additional lossy screw, or lossy tuning element, in the bandpass filter with orientation in the same fashion relative to the other screws as described in the arrangement of the group-delay equalizer. In either case, adjustment of the spectral characteristic, thereby, is integral to the filter or group-delay equalizer structure, and does not require a separate amplitude equalizer. Connection of the bandpass filter to the group-delay equalizer is accomplished, in a preferred embodiment of the invention, by means of a circulator. The invention may be employed in microwave structures having other arrangements of electrically conductive screws for tuning and/or mode coupling, wherein one or more of the electrically conductive screws, or tuning elements, may be replaced with one or more corresponding lossy screw(s), or wherein an additional lossy screw(s) may be added to the microwave structure. The invention is beneficial because the lossy screws, or lossy tuning elements, can be incorporated into the filter assembly without negatively affecting VSWR (voltage standing wave ratio), group delay, or band rejection characteristics, while improving the passband flatness.

### BRIEF DESCRIPTION OF THE DRAWING

The aforementioned aspects and other features of the invention are explained in the following description, taken in connection with the accompanying drawing figures wherein:

FIG. 1 shows a stylized view of a filter assembly constructed in accordance with the invention,

FIG. 2 is a set of graphs explaining operation of a group-delay equalizer of FIG. 1;

FIG. 3 shows a cross-sectional view of the group-delay equalizer taken along line 3-3 in FIG. 1; and

FIG. 4 is a graph showing amplitude versus frequency response of the filter assembly of FIG. 1, wherein a solid trace shows the response provided by the invention, and a dashed trace shows the response in the absence of the invention.

Identically labeled elements appearing in different ones of the figures refer to the same element but may not be referenced in the description for all figures.

### DETAILED DESCRIPTION OF THE INVENTION

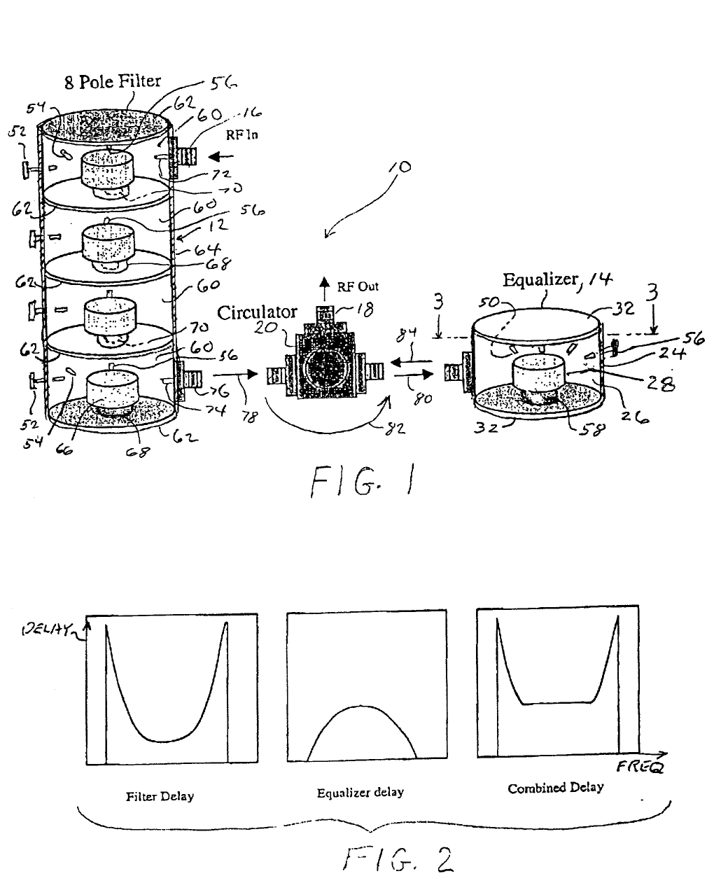

With reference to FIG. 1, a filter assembly 10, which is suitable for use in transmission and reception of signals in a satellite communication system, comprises a bandpass filter 12 and a group-delay equalizer 14. By way of example, the bandpass filter 12 is shown as an eight-pole filter, however, the filter may be constructed with some other number of poles such as six poles, if desired. An input microwave port 16 of the filter assembly 10 connects with the filter 12, and an output microwave port 18 of the filter assembly 10 connects with the equalizer 14. A circulator 20 is connected between the filter 12 and the equalizer 14 to couple electromagnetic signals between an output of the filter 12 and an input of the equalizer 14. Directions of signal flow are indicated by arrows, The filter 12 and the equalizer 14 are each constructed with a cavity having tuning elements, such as tuning screws disposed therein, and may also include a centrally disposed resonator, such a as a ceramic resonator useful in tuning the passband of the filter assembly 10 for the transmission of microwave signals.

In accordance with the invention, the arrangement of the tuning elements is altered by the inclusion of a lossy tuning element, as will be described with reference to FIG. 3, in the bandpass filter 12 and/or the equalizer 14 for improvement of the spectral response of the filter assembly 10 in providing a flat response of signal amplitude versus signal carrier frequency. In order to facilitate the description of the invention, FIG. 3 shows details in the construction of the group-delay equalizer 14, including the provision of a lossy tuning screw of the invention, it being understood that this description applies equally well to the implementation of the invention within the bandpass filter 12 as in the group-delay equalizer 14.

With reference to each of the three graphs of FIG. 2, group delay is shown on the vertical axis, and frequency is shown on the horizontal axis. The graph on the left shows that the group delay of the bandpass filter 12 varies with frequency, and has maximum values of delay at both ends of the passband with a lesser amount of delay in the mid-band region. The middle graph shows that the equalizer introduces a group delay which varies with frequency such that a maximum amount of delay is introduced in the mid-band region, with lesser delay being introduced at both ends of the passband. The signal propagating through the filter assembly 10 (FIG. 1) experiences the contributions of the group delay of both the bandpass filter 12 and the equalizer 14, this resulting in the sum of the delays as is portrayed in the graph at the right of FIG. 3. The graph at the right shows that the equalizer 14 is operative to flatten the central portion of the filter passband, which portion is employed in the transmission of the signal through the filter assembly 10.

With reference to FIGS. 1 and 3, the group-delay equalizer 14 is constructed of a housing 22 with an exterior wall 24 enclosing a right circular cylindrical cavity 26, A disk shaped ceramic resonator 28 is disposed along a central cylindrical axis 30 of the cavity 26. End walls 32 of the equalizer 14 connect with the wall 24 and close off the cavity 26, one of the end walls 32 serving to support and to locate the resonator 28 within the cavity 26. For ease of reference, the wall 24 may be described (with reference to the orientation of the equalizer shown in FIG. 3) as having an outer surface composed of a top surface 34, a bottom surface 36, a right surface 38 and a left surface 40 which are joined together by inclined surfaces 42 and 44 respectively at the left and the right edges of the top surface 36, and by inclined surfaces 46 and 48 respectively at the left and the right edges of the bottom surface 36. The inclined surfaces are inclined at 45 degrees relative to the top and the bottom surfaces.

Four tuning elements in the form of electrically conducting screws 50, 52, 54 and 56 are shown disposed in the exterior wall 24, and being oriented with their respective axes intersecting the cylindrical axis 30. The screw 50 is located in the inclined surface 42, the screw 52 is located in the top surface 34, the screw 54 is located in the inclined surface 44, and the screw 56 is located in the right surface 38. By rotation of the screws 50, 52, 54 and 56, respective ones of the screws can be advanced into the cavity 26 a desired amount for tuning the group-delay equalizer 14 for transmission of each of two orthogonal electromagnetic waves propagating within the equalizer 14. The tuning screw 52 interacts with the electric field of a vertically polarized one of the waves, and the tuning screw 56 interacts with the electric field of a horizontally polarized one of the waves. The tuning screw 54 is oriented at 45 degrees relative to the screws 52 and 56 for interaction with both of the waves to serve as a mode coupling screw for coupling electromagnetic energy between the two waves.

In accordance with the invention, the tuning screw 50 serves as the lossy tuning screw, and has less electrical conductivity than do the other tuning screws 52, 54 and 56. The lossy tuning screw 50 is perpendicular to the mode-coupling screw 54 for interaction with both of the electromagnetic waves. The lossy tuning screw 50, in a preferred embodiment of the invention, is constructed with titanium to increase its resistivity, as compared to the resistivity of the screws 52, 54 and 56 which are silver plated, preferably, in the preferred embodiment of the invention. Due to the increased resistivity of the lossy tuning screw 50, more electromagnetic energy is withdrawn by the lossy tuning screw 50 then the negligible withdrawal of energy by any of the screws 52, 54 and 56. The amount of energy withdrawn is frequency dependent in accordance with the depth of penetration of the lossy tuning screw 50 into the cavity 26. Adjustment of the tuning screw 50 in conjunction with adjustment of the tuning screws 52, 54 and 56 provides for attainment of improved flatness to the spectral characteristic of amplitude versus frequency than can be obtained by use of only the three screws 52, 54 and 56. Thereby, the invention provides for improved spectral characteristic to the filter assembly 10.

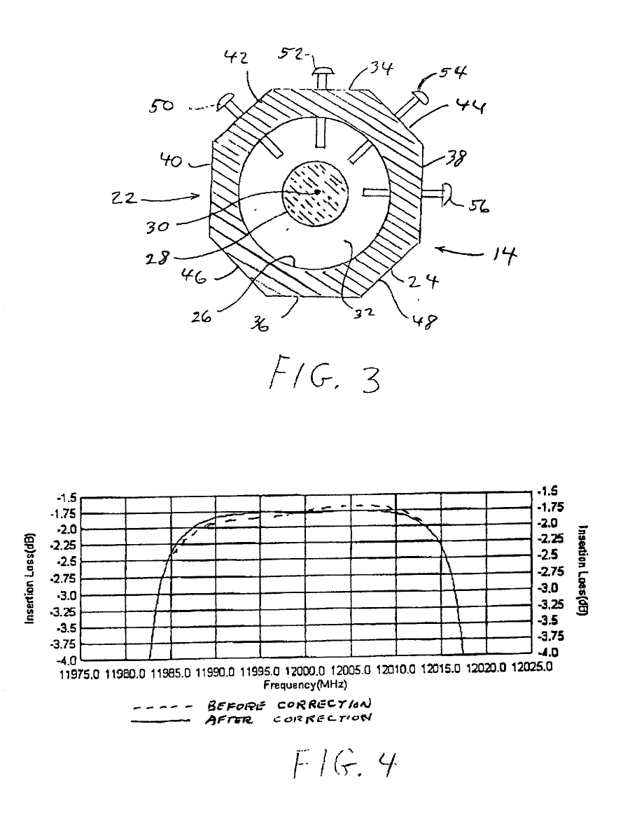

FIG. 4 shows a graph of the spectral characteristic of amplitude versus frequency of the filter assembly 10, wherein amplitude is shown on the vertical axis and frequency is shown on the horizontal axis, FIG. 4 shows the beneficial results of the invention in adjustment of the amplitude versus frequency characteristic of the passband of the filter assembly 10. In the absence of the lossy tuning screw 50 of the invention, there is a greater absorption of microwave energy at the lower frequencies of the passband than at the upper frequencies of the passband resulting in the skewed appearance of amplitude represented by the dashed trace. Upon implementation of the invention by use of the lossy tuning screw 50, the distribution of energy absorbed over the passband of the filter assembly 10 is altered to provide the essentially flat and uniform distribution of energy, as a function of frequency, propagating through the filter assembly 10, as is represented by the solid trace.

As shown in FIG. 1, in the equalizer 14, the resonator 28 is held at a predetermined distance from one of the end walls 32 by a supporting structure, which may be referred to as a pedestal 58, and is constructed of a cylindrical low-loss ceramic element secured by a suitable means, such as an adhesive, to an end surface of the resonator 28 and to the end wall 32. The resonator 28 is constructed of a ceramic disk in the shape of a right-circular cylinder wherein the ratio of the diameter of the disk to the thickness of the disk is greater than 2. The exterior wall 24 and the end wall 32 of the equalizer 14 may be fabricated of aluminum. The dielectric constant of the resonator 28 has a value typically in the range of 30-36. Most of the energy of the field is located within the resonator 28, and a relatively small amount of the energy is located within an evanescent mode within the cavity and outside of the resonator 28. The presence of the resonator 28 within the cavity 26 allows for the construction of a much smaller cavity for resonating at the desired frequency as compared to the physical size of such a cavity in the absence of the resonator. By way of example, the cavity of an equalizer which is dielectrically loaded with the ceramic resonator, as is the case with the equalizer 14 of the invention, is approximately ⅓ to ¼ the size of an unloaded cavity.

The foregoing features in the construction of the equalizer 14 may be applied also in the construction of the bandpass filter 12. Thus, the bandpass filter 12, in the preferred embodiment of the invention, comprises four cavities 60 separated by end walls 62, with two additional end walls 62 located at opposite ends of the assembly of the filter 12, the assembly of the filter 12 being enclosed by an encircling cylindrical wall 64 which contacts the end walls 62. To reduce the overall size of the bandpass filter 12, it is advantageous to load the cavities 60 with dielectric resonators 66, the resonators 66 being positioned by pedestals 68 to respective ones of the end walls 62. The pedestals 68 are essentially transparent to the microwave radiation at the frequency of operation of the filter assembly 10, such as at a frequency of 12 Ghz (gigahertz) employed in the preferred embodiment of the invention. Accordingly, is convenient to couple the cavities 60 by means of irises 70 located in respective ones of the end walls 62 beneath individual ones of the pedestals 68. They irises may be circular or cross shaped in accordance with the usual practice in construction of microwave filters,

The number of the poles of the filter 12 can be doubled by generation of two orthogonal modes of wave propagation within the filter 12. This can be accomplished by introducing the screws 52, 54 and 56, described above with reference to the construction of the equalizer 14, into the cavities 60 located at the ends of the filter 12, some of these screws being indicated in FIG. 1. For example, in the top cavity 60 of the filter 12, a screw 52 can interact with a microwave signal input by a probe 72 of the port 16 to generate a first mode of microwave propagation while interacting with screws 54 and 56 to introduce a second orthogonal mode of microwave propagation. Probes 52 and 56 in the other ones of the cavities 60 participate in the propagation of the two orthogonal modes. In the bottom cavity 60, the screw 54, mounted at the 45 degree angle position, enables coupling of microwave energy from both of the modes via the screw 52 to a probe 74 at the port 76 of the filter 12 for coupling, by a single mode, microwave signals between the filter 12 and the circulator 20. If desired, the lossy probe 50, described in FIG. 3 with reference to the equalizer 14, may be positioned in one or more of the cavities 60 of the filter 12 to cooperate with the lossy screw 50 of the equalizer 14 in adjustment of the characteristic of amplitude vs. frequency as described above with reference to FIG. 4.

With respect to the operation of the circulator 20 (FIG. 1), the circulator 20 is a three-port circulator, wherein a first port connects with the filter port 76 to receive a signal, indicated at arrow 78, and a second port serves to output a signal, indicated at arrow 80, to the equalizer 14. The circulator 20 is constructed in well-known form such as a stripline structure with ferromagnetic material and an applied magnetic field to provide for a circulating propagation path indicated by arrow 82. Signals reflecting back from the equalizer 14, indicated at arrow 84, output the circulator 20 at port 18. The equalizer cavity 26 resonates at the same frequency as does the bandpass filter 12, and thus the reflection causes a time delay only for those frequencies which are contained in the passband of the filter. Both the signals at arrows 80 and 84 are single mode signals, while the two orthogonal modes appear within the equalizer 14.

With respect to the operation of the filter assembly 10 (FIG. 1), it is noted that generally, most of the coupling within a filter or equalizer are positive couplings, as determined by standard coupling matrices of filters. When these couplings, such as irises and tuning screws, have a finite Q (quality factor), dissipated loss affects the low-frequency, or the lower side of the filter passband. If a negative coupling is introduced, as in the case of the screw 50 (FIG. 3) oriented perpendicularly to the mode-coupling screw 54 that provides for a positive coupling, a finite Q here will tend to affect the upper frequencies, or the right side of the passband. Since filters will always have a majority of positive couplings, the effect of a finite Q for these couplings is typically a roll-off of the left side of the passband. The invention introduces a negative coupling, and this adds more loss (via lossy material in the lossy screw 50) than does the typical silver plated screw, such as the screws 52, 54 and 56, so as to compensate for the higher amount of positive couplings in the filter. A tuning screw, such as the tuning screw 50, is a convenient way to introduce the negative lossy coupling because both the amount of the coupling and the amount of the loss can be controlled by adjustment of the depth of the tuning screw and appropriate selection of the material from which the tuning screw is constructed.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A filter assembly comprising:
an electromagnetic wave propagation structure having a cavity with a plurality of tuning elements extending therein, the wave-propagation structure supporting a first wave propagating in a first mode and a second wave propagating in a second mode, wherein a first of said tuning elements is positioned to interact with the first wave, a second of said tuning elements is positioned to interact with the second wave, and a third of said tuning elements is positioned for coupling electromagnetic energy between the first wave and the second wave; and
wherein a fourth of said tuning elements has an orientation transverse to an orientation of said third tuning element, each of said first and said second and said third tuning elements is essentially non-lossy while said fourth tuning element is lossy relative to each of said first and said second and said third tuning elements for control of a spectral characteristic of amplitude versus frequency of said filter assembly.

2. A filter assembly according to claim 1, further comprising a bandpass filter and a group-delay equalizer coupled thereto, wherein said wave propagation structure is located in said group-delay equalizer.

3. A filter assembly according to claim 1, further comprising a bandpass filter and a group-delay equalizer coupled thereto, wherein said wave propagation structure is located in said bandpass filter.

4. A filter assembly according to claim 1, wherein said fourth tuning element has a resistivity greater than a resistivity of any of said first and said second and said third tuning elements by a factor in a range of 1.1 to 10.

5. A filter assembly according to claim 1, wherein said first and said second tuning elements are coplanar and are perpendicular to each other.

6. A filter assembly according to claim 5, wherein said third tuning element is angled at 45 degrees relative to said second tuning element.

7. A filter assembly according to claim 6, wherein said fourth tuning element is perpendicular to said third tuning element.

8. A filter assembly according to claim 1, wherein a penetration of said fourth tuning element into said cavity is adjustable.

9. A filter assembly according to claim 8, wherein said fourth tuning element has the structure of a screw, and the penetration of said fourth tuning element into said cavity is adjustable by rotation of the screw.

10. A filter assembly according to claim 1, wherein said wave propagation structure further comprises a resonator located in said cavity, said resonator being a ceramic resonator.

11. A filter assembly according to claim 10, wherein said resonator is a ceramic resonator located on a central axis of said cavity, and each of said tuning elements is directed toward said central axis.

12. A filter assembly according to claim 1, further comprising a bandpass filter, a group-delay equalizer and a circulator interconnecting said bandpass filter with said group-delay equalizer, wherein said wave propagation structure is located in said bandpass filter, and said wave propagation structure comprises a resonator located in said cavity, said resonator being a ceramic resonator having a dielectric constant in the range of 30-36.

13. The filter assembly according to blame 12 wherein said wave propagation structure is a first wave propagation structure, the filter assembly further comprising a second wave propagation structure located in said group-delay equalizer, wherein said second wave propagation structure includes a cavity with a ceramic resonator located therein and a plurality of tuning screws extending inwardly from a wall of said cavity toward said resonator, and wherein, in said second wave propagation structure, two of said tuning screws support two orthogonal modes of waves, a third of said tuning screws is a mode coupling screw angled relative to said first two screws, and a fourth of said tuning screws is perpendicular to said third screw for introducing loss to waves propagating in each of said orthogonal modes.
